(19) United States
(12) Patent Application Publication
(10) Pub. No.: US 2022/0183485 A1
(43) Pub. Date: Jun. 16, 2022

(54) SMART COFFEE CUP AND OTHER DISHWARE

(71) Applicant: Eddie Rafii, Laguna Niguel, CA (US)

(72) Inventor: Eddie Rafii, Laguna Niguel, CA (US)

(21) Appl. No.: 17/247,502

(22) Filed: Dec. 14, 2020

(51) Int. Cl. A47G 19/22; A47G 19/03; G08B 21/18

(52) U.S. Cl. CPC A47G 19/2227; A47G 19/03; A47G 2019/2244; A47G 2019/225; G08B 21/182

(57) ABSTRACT

Dishware having a body configured to hold a heated liquid; a temperature sensor integrated into the body, the temperature sensor positioned and configured to detect a temperature of the heated liquid; and an alarm configured to alert a user when the temperature is within a threshold range. The temperature sensor, via a transmitter, may communicate with a mobile device to alert the user to the temperature of the liquid contents. A software application (“App”) provides a user interface relative to the communications between the temperature sensor and the mobile device. The dishware may be of a conventional type or disposable in nature (e.g., Starbucks cup).

### FIELD OF THE INVENTION

The embodiments of the present invention relate to smart dishes including coffee mugs configured to sense and report coffee temperatures to users.

### BACKGROUND

It can be challenging to determine when hot liquids, such as coffee and tea, are at an appropriate temperature to drink. Drinking liquids that are too hot can cause discomfort and even injury. People tend to check the temperature of heated liquids by taking a tiny sip or inserting a finger into the liquid. Such actions may still cause injury and are non-hygienic.

It would be advantageous to develop dishware that senses the temperature of its contents and alerts the person intending to ingest the contents.

### SUMMARY

Accordingly, one embodiment of the present invention is directed to dishware comprising a body configured to hold a heated liquid; a temperature sensor integrated into said body, said temperature sensor positioned and configured to detect a temperature of said heated liquid; and an alarm configured to alert a user when said temperature is within a threshold range.

In another embodiment, the temperature sensor, via a transmitter, communicates with a mobile device to alert the user to the temperature of the liquid contents. A software application (“App”) provides a user interface relative to the communications between the temperature sensor and the mobile device.

The dishware may be of a conventional type or disposable in nature.

Other variations, embodiments and features of the present invention will become evident from the following detailed description, drawings and claims.

### BRIEF DESCRIPTION OF THE DRAWINGS

FIG. 1 illustrates a block diagram of a first embodiment of the present invention according to the embodiments of the present invention;

FIG. 2 illustrates a block diagram of a second embodiment of the present invention according to the embodiments of the present invention;

FIGS. 3A and 3B show temperature sensor placements on an exemplary coffee cup according to the embodiments of the present invention;

FIGS. 4A and 4B illustrate a series of screen shots of a screen of a mobile device according to the embodiments of the present invention;

FIG. 5 illustrates a reusable temperature sensor and alarm according to the embodiments of the present invention;

FIG. 6 illustrates a reusable temperature sensor and transmitter according to the embodiments of the present invention;

FIG. 7 illustrates a flow chart detailing one operational methodology according to the embodiments of the present invention;

FIG. 8 illustrates a flow chart detailing a second operational methodology according to the embodiments of the present invention;

FIG. 9 illustrates another embodiment with a temperature sensor and alarm integrated into the dishware; and

FIG. 10 illustrates another embodiment with a temperature sensor and transmitter integrated into the dishware.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The individual parts of the dishware may be fabricated of metals, plastics, composites, alloys, polymers and combinations thereof. The individual parts of the dishware may be fabricated using suitable techniques including molding, machining, rapid prototyping, casting and combinations thereof.

In broadest terms, the dishware described herein includes a body, temperature sensor, and/or alarm, transmitter and receiver. The details below focus on permanent and disposable coffee cup or mug. Those skilled in the art will recognize that other dishware may benefit from the embodiments of the present invention. Moreover, any types of liquids may be the target of the temperature sensor including coffees, teas, soups, water and the like.

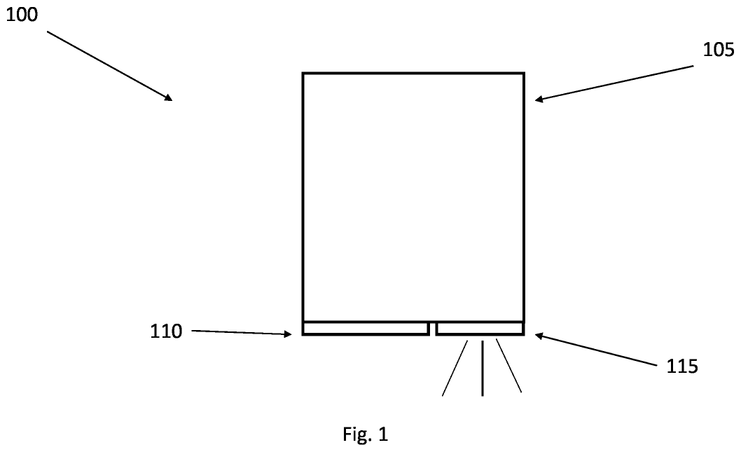

FIG. 1 shows a block diagram 100 of a first embodiment of the present invention. The block diagram 100 shows a body 105 (e.g., coffee mug), temperature sensor 110 and alarm 115. In one embodiment, the temperature sensor 110 is an integrated circuit (IC) temperature sensor of the type manufactured by Omega Engineering located in India. An IC temperature sensor is a two terminal integrated circuit temperature transducer that produces an output current proportional to absolute temperature. In one embodiment, the temperature sensor 110 and alarm 115 may be a single device.

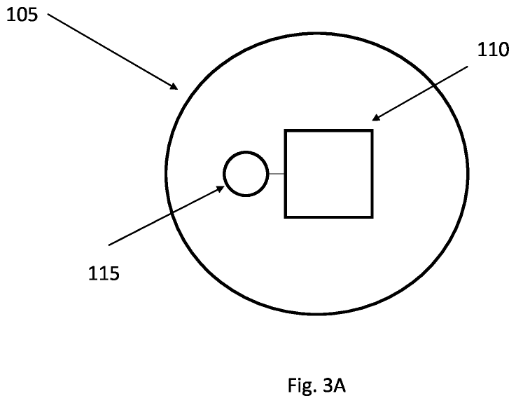

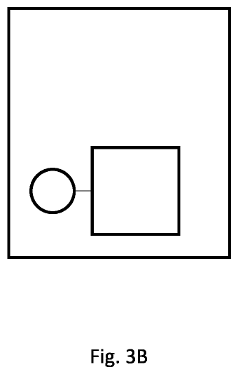

In one embodiment, as shown in FIG. 3A, the IC temperature sensor 110 is integrated into or onto the body 105 at a bottom thereof. In another embodiment, as shown in FIG. 3B, the IC temperature sensor 110 is integrated into or onto a side of the body 105 near a bottom thereof. Positioning at or near the bottom ensures that temperatures of even small amounts of liquid can be obtained given such liquids will reside at the bottom of the body 105. In one embodiment, the alarm 115 is audible. Alternatively, the alarm 115 may take other forms such as a flashing light.

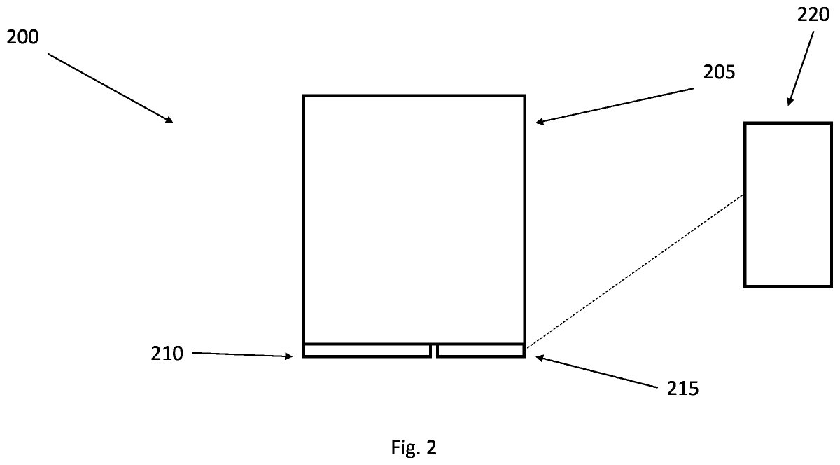

FIG. 2 shows a block diagram 200 of a second embodiment of the present invention. The block diagram 200 shows a body 205 (e.g., coffee mug), temperature sensor 210 and transmitter 215. In one embodiment, the temperature sensor 210 is an integrated circuit (IC) temperature sensor. Like the embodiment shown in the bottom view of FIG. 3A, the IC temperature sensor 210 may be integrated into or onto the body 205 at a bottom thereof. Like the embodiment shown in the side view of FIG. 3B, the IC temperature sensor 210 may be integrated into or onto a side of the body 205 near a bottom thereof. In one embodiment, the temperature sensor 210 and transmitter 215 are a single device.

The transmitter 215, which is in communication with the temperature sensor 210, may be positioned adjacent to the temperature sensor 210 or elsewhere on the body 205. The transmitter 215 serves to transmit a signal to a mobile device 220 (e.g., smart phone) to notify the user that the liquid is within a pre-established temperature range suitable for ingestion. Alternatively, the transmitter 215 may send a first signal when the temperature drops below a maximum threshold temperature and a second signal when the temperature reaches a minimum threshold temperature. In one embodiment, the transmitter 215 utilizes Bluetooth or other short-range technology to communicate with the mobile device 220.

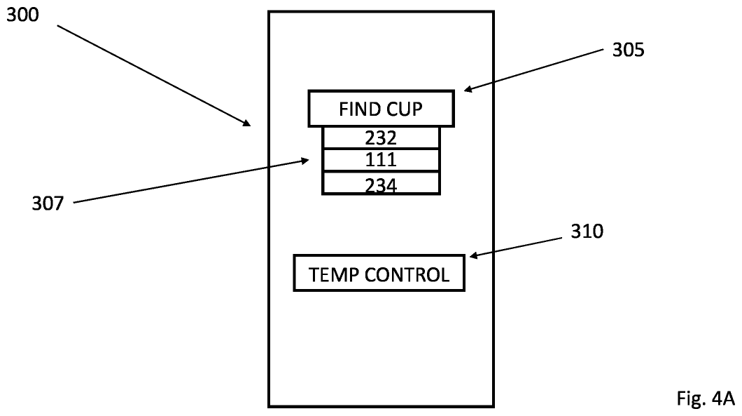

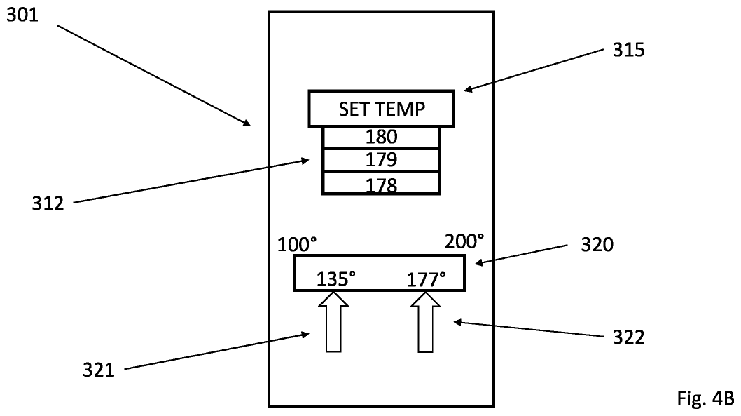

With the second embodiment, the mobile device 220 is used to download and store an App which acts as an interface for the user. The App, like most Apps, is obtained through a dedicated website or link, and downloaded into the memory of the mobile device 220. FIG. 4A shows a home screen 300 of such an exemplary App. The home screen 300 includes a drop-down window 305 for the user to link to the subject transmitter 215. In one embodiment, the transmitter 215 (or temperature sensor 210) has a readily identifiable number or symbol 307 that the user can use to identify the subject transmitter 210. This is useful in coffee shop or restaurant settings where the user may be in a crowd of people having newly poured cups of coffee.

The home screen 300 also includes an active temperature control icon 310 allowing the user to set a desired temperature or range of temperatures. FIG. 4B shows a temperature control screen 301 reached via the temperature control icon 310. The user may set a desired temperature via drop down temperature window 315 with select temperatures 312 and a temperature range via temperature range slider 320 having a minimum arrow 321 and maximum arrow 322. Temperature control screen 301 also includes an alarm setting icon 325 for the user to set one or more alarms. The App may come with default settings such as a first alarm at 175° (max temperature) and a second alarm at 115° (minimum temperature). Alternatively, a default alarm sounds when the liquid reaches a safe drinkable warm temperature (e.g., 100°). The home screen 300 also shows the user's alarm settings 330 for easy reference.

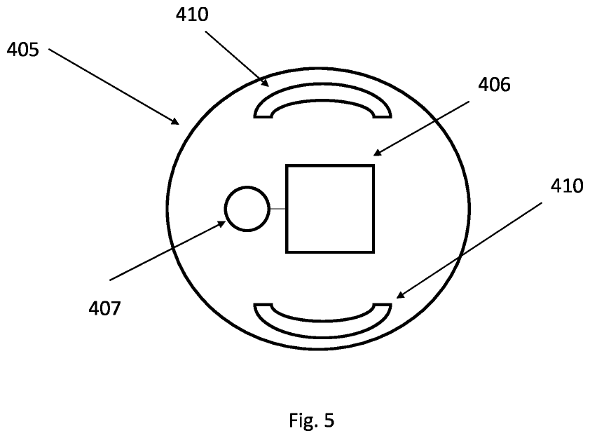

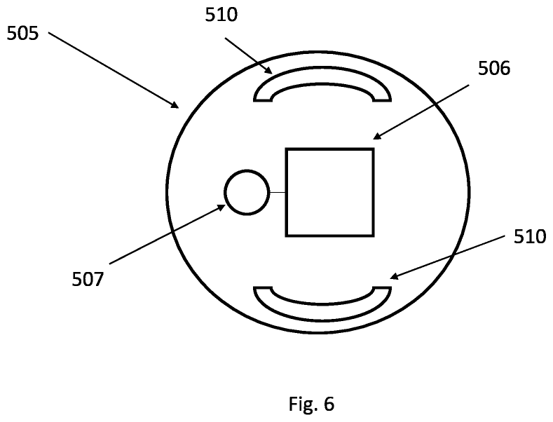

FIGS. 5 and 6 illustrate a reusable temperature sensor and alarm 405 and reusable temperature sensor and transmitter 505, respectively, according to the embodiments of the present invention. Rather than integrated into the body, the reusable temperature sensor and alarm 405 unit, comprising a temperature sensor 406 and alarm 407, and the reusable temperature sensor 505 unit comprising a temperature sensor 506 and transmitter 507 may be removably adhered to a body. In one embodiment, the reusable temperature sensor and alarm 405 and reusable temperature sensor and transmitter 505 may be adhered to a bottom of a body using a layer of adhesive 410, 510 on the reusable temperature sensor and alarm 405 and reusable temperature sensor and transmitter 505. For example, the layer of adhesive 410, 510 may last 10-20 applications before needing to be disposed of. The life of the layer of adhesive 410, 510 may be prolonged by an adhesive cover used to protect the layer of adhesive 410, 510 when the reusable temperature sensor and alarm 405 and reusable temperature sensor and transmitter 505 are not in use.

While the reusable temperature sensor and alarm 405 unit and the reusable temperature sensor 505 unit are shown as circular, they may take on other shapes and configurations based on the body on which they are intended to be used.

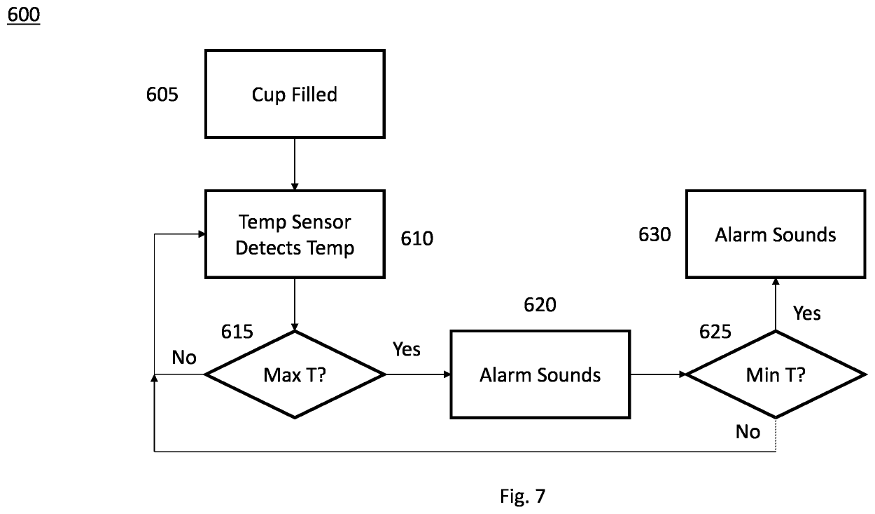

FIG. 7 shows a flow chart 600 detailing one operational methodology according to the embodiments of the present invention. At 605, a coffee cup is filled with hot coffee. At 610, a temperature sensor begins detecting the temperature of the coffee in the cup. At 615, it is determined if the temperature is at or below a maximum threshold temperature (T). If so, at 620, an audible alarm, in communication with the temperature sensor, sounds to alert the user that the temperature of the coffee can be ingested safely. At 625, it is determined if the temperature is at a minimum threshold temperature (T). If so, at 630, the audible alarm sounds again to alert the user that the temperature of the coffee is beginning to get cold.

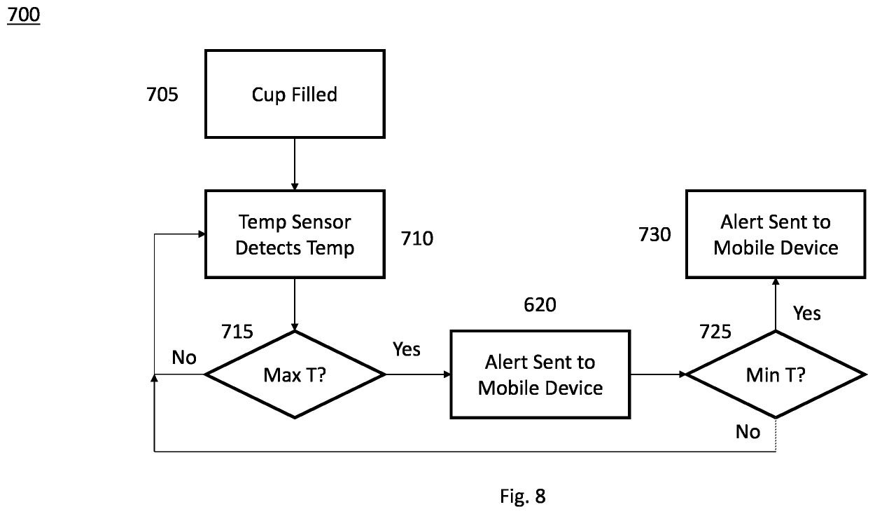

FIG. 8 shows a flow chart 700 detailing one operational methodology according to the embodiments of the present invention. At 705, a mobile device is synced with a subject coffee cup. At 710, the user sets temperature and alert parameters. At 710, the temperature sensor begins detecting the temperature of the coffee in the cup. At 715, it is determined if the temperature is at a maximum threshold temperature. If so, at 720, a transmitter, in communication with the temperature sensor, sends an alert to the user's mobile device indicating that the temperature of the coffee can be ingested safely. At 725, it is determined if the temperature is at a minimum threshold temperature. If so, at 730, the transmitter again sends an alert to the user's smart mobile device indicating that the temperature of the coffee is beginning to get cold.

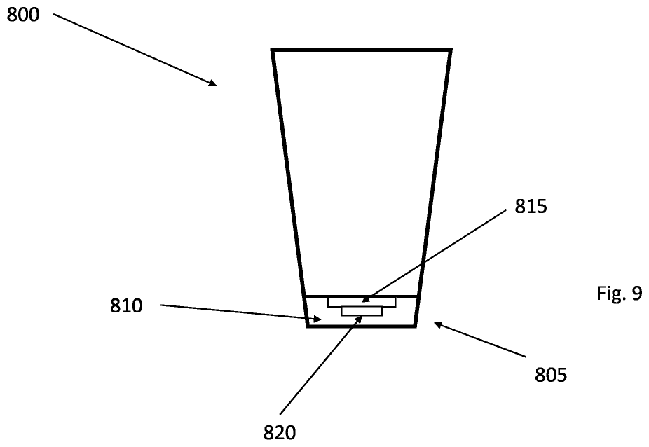

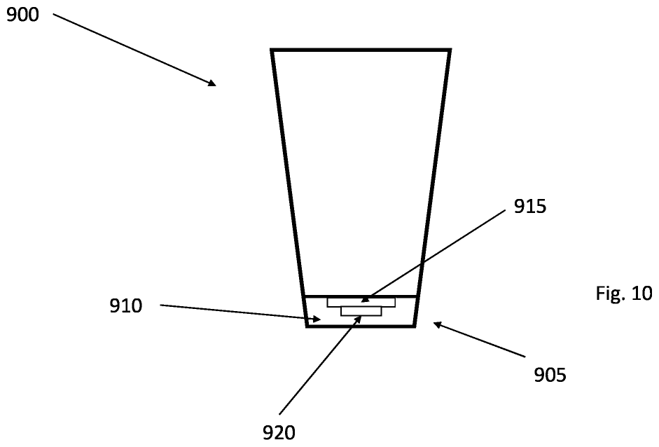

FIG. 9 shows a cup 800 with a bottom 805 including an internal compartment 810 retaining a temperature sensor 815 and alarm 820. FIG. 10 shows a cup 900 with a bottom 905 including an internal compartment 910 retaining a temperature sensor 915 and transmitter 920 configured to communicate with a mobile device 925.

The embodiments detailed herein may be used with various types of dishware including paper cups, cardboard cups, glass cups, metal containers as well as bowls, mugs, and any other liquid containers which permit heat to be radiated from within.

Although the invention has been described in detail with reference to several embodiments, additional variations and modifications exist within the scope and spirit of the invention as described and defined in the following claims.

I claim:

1. An article comprising:
a piece of dishware including a body having a bottom;
a temperature sensor on said body near a bottom of thereof, said temperature sensor positioned and configured to detect a temperature of a liquid within said dishware;
an alarm integrated on said body near a bottom of thereof, said alarm in communication with said temperature sensor; and
wherein said temperature sensor is configured to trigger said alarm responsive to detecting one or more threshold temperatures.

2. The article of claim 1 wherein said alarm is audible.

3. The article of claim 1 wherein said dishware is mug or cup.

4. The article of claim 3 wherein said temperature sensor is on a bottom of said mug or cup.

5. The article of claim 3 wherein said temperature sensor is on a side of said mug or cup near a bottom thereof.

6. The article of claim 1 wherein said temperature sensor and alarm are a single device.

7. The article of claim 1 wherein said dishware is paper or cardboard.

8. An article comprising:
a piece of dishware including a body having a bottom;
a temperature sensor integrated into a bottom portion of said body, said temperature sensor positioned and configured to detect a temperature of a liquid within said dishware;
a transmitter integrated into said bottom portion of said body, said transmitter in communication with said temperature sensor; and
wherein said temperature sensor is configured to trigger said transmitter to send an alert to a mobile device responsive to detecting one or more threshold temperatures.

9. The article of claim 8 wherein said dishware is mug or cup.

10. The article of claim 9 wherein said temperature sensor is integrated into a bottom of said mug or cup.

11. The article of claim 9 wherein said transmitter is integrated into a bottom of said mug or cup.

12. The article of claim 8 wherein said temperature sensor and transmitter are a single device.

13. The article of claim 8 wherein said dishware is paper or cardboard.

14. A system comprising:
a piece of dishware including a body having a bottom;
a temperature sensor integrated into a bottom portion of said body, said temperature sensor positioned and configured to detect a temperature of a liquid within said dishware;
a transmitter integrated into said bottom portion of said body, said transmitter in communication with said temperature sensor;
a software application stored in memory of a mobile device; and
wherein said temperature sensor is configured to trigger said transmitter to send an alert to said mobile device responsive to detecting one or more threshold temperatures.

15. The system of claim 14 wherein said software application acts as a user interface.

16. The system of claim 14 wherein said dishware is mug or cup.

17. The system of claim 16 wherein said temperature sensor is integrated into a bottom of said mug or cup.

18. The system of claim 16 wherein said transmitter is integrated into a bottom of said mug or cup.

19. The system of claim 14 wherein said temperature sensor and transmitter are a single device.

20. The system of claim 14 wherein said software application permits threshold temperatures and/or alerts to be set.

21. The system of claim 14 wherein said dishware is paper or cardboard.
